(19) United States
(12) Patent Application Publication
(10) Pub. No.: US 2025/0129105 A1
(43) Pub. Date: Apr. 24, 2025

(54) PURIFICATION OF METAL HALIDE PRECURSORS

(71) Applicant: ENTEGRIS, INC., Billerica, MA (US)

(72) Inventors: Vagulejan Balasanthiran, Pennsburg, PA (US); Scott A. Laneman, Vernon Hills, IL (US); Iryna Alshakova, Philadelphia, PA (US); Smita Patnaik, Warrington, PA (US)

(21) Appl. No.: 18/923,420

(22) Filed: Oct. 22, 2024

Related U.S. Application Data
(60) Provisional application No. 63/545,490, filed on Oct. 24, 2023.

(51) Int. Cl. C07F 5/00

(52) U.S. Cl. CPC C07F 5/003

(57) ABSTRACT

Method for purifying metal halide precursors, and related compositions, related methods, and the like. A method comprises one or more of the following steps: obtaining a metal halide precursor, the metal halide precursor comprising a metal halide compound and at least one impurity; contacting the metal halide precursor with an oxygen-containing compound in a presence of a polar oxygen-free solvent to form a reaction product in solution; and separating the reaction product from at least one of at least a portion of the at least one impurity, at least a portion of the solution, or any combination thereof. Other compositions and methods are provided herein.

### CROSS-REFERENCE TO RELATED APPLICATIONS

This application claims the benefit under 35 USC 119 of U.S. Provisional Patent Application No. 63/545,490, filed Oct. 24, 2023, the disclosure of which is hereby incorporated herein by reference in its entirety.

### FIELD

The present disclosure relates to the purification of metal halide precursors and related compositions and related methods.

### BACKGROUND

Metal halide precursors contain impurities. Removing impurities from metal halide precursors remains an ongoing challenge.

### SUMMARY

Some embodiments of the present disclosure relate to a method. In some embodiments, the method comprises obtaining a metal halide precursor. In some embodiments, the metal halide precursor comprises a metal halide compound and at least one impurity. In some embodiments, the method comprises contacting the metal halide precursor with an oxygen-containing compound in a presence of a polar oxygen-free solvent to form a reaction product in solution. In some embodiments, the method comprises separating the reaction product from at least one of at least a portion of the at least one impurity, at least a portion of the solution, or any combination thereof.

Some embodiments relate to a composition. In some embodiments, the composition comprises an adduct. In some embodiments, the adduce comprises a reaction product. In some embodiments, the adduce comprises a metal halide compound and an oxygen-containing compound. In some embodiments, the oxygen-containing compound is coordinated to the metal halide precursor. In some embodiments, the adduct is present in the composition at a purity of at least 50%.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a flowchart of a method for removing at least one impurity from a reaction, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Metal halide precursors may contain various impurities, such as, for example and without limitation, metal oxide compounds, metal hydroxide compounds, metal hydrate compounds, and the like. These impurities may be a result of the synthesis of the metal halide compounds present in the metal halide precursors and/or may be a result of oxidation and/or reaction with air, among other things. The presence of the impurities in the metal halide precursors may lead to the formation of undesirable byproducts, lower yield and/or conversion, among other things, when the metal halide precursors are used in the synthesis of other compounds.

Some embodiments provide methods for removing impurities from metal halide precursors. That is, in some embodiments, for example, methods for purifying metal halide precursors with ease via a simple, one-pot synthesis, are provided. The metal halide precursors may comprise a metal halide compound and at least one impurity. In some embodiments, the methods for purifying the metal halide precursors may be employed to obtain a metal halide compound with high yield. For example, in some embodiments, a metal halide compound may be isolated form the at least one impurity with a yield of 98% or greater. In some embodiments, a purity of the metal halide compounds is at least 99% or greater. In some embodiments, the metal halide compounds may be stored as a solid under inert conditions.

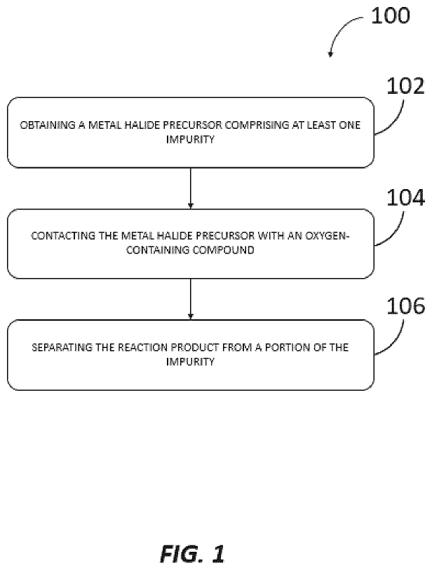

FIG. 1 is a flowchart of a method for purifying a metal halide precursor, according to some embodiments. As shown in FIG. 1, the method 100 for purifying a metal halide precursor comprises one or more of the following steps: obtaining 102 metal halide precursor, the metal halide precursor comprising a metal halide compound and at least one impurity; contacting 104 the metal halide precursor with an oxygen-containing compound in a presence of a polar oxygen-free solvent to form a reaction product in solution; and separating 106 the reaction product from at least one of at least a portion of the at least one impurity, at least a portion of the solution, or any combination thereof. In some embodiments, the method does not comprise a filtering step between the step of obtaining and the step of contacting. In some embodiments, the method does not comprise use of a non-polar solvent. In some embodiments, the method does not comprise use of hexane.

At step 102, in some embodiments, the method 100 comprises obtaining a metal halide precursor.

The metal halide precursor may comprise a metal halide compound. In some embodiments, for example, the metal halide compound comprises at least one of yttrium chloride, yttrium bromide, yttrium iodide, yttrium fluoride, or any combination thereof. In some embodiments, the metal halide precursor comprises at least one of YCl₃, YBr₃, YI₃, or any combination thereof.

The metal halide precursor may comprise at least one impurity. The at least one impurity may be present in at least one of a solid phase, a liquid phase, a gas/vapor phase, or any combination thereof. In some embodiments, the at least one impurity comprises at least one of a volatile impurity, a non-volatile impurity, or any combination thereof. In some embodiments, the at least one impurity comprises at least one impurity that is insoluble in the solution. In some embodiments, the at least one impurity comprises at least one of a metal oxide, a metal hydroxide, a metal hydrate compound, or any combination thereof. For example, in some embodiments, the at least one impurity comprises at least one of a yttrium oxide compound, a yttrium hydroxide compound, a yttrium hydrate compound, or any combination thereof.

At step 104, in some embodiments, the method 100 comprises contacting the metal halide precursor with an oxygen-containing compound in a presence of a polar oxygen-free solvent to form a reaction product in solution.

In some embodiments, the contacting comprises bringing the metal halide precursor, the oxygen-containing compound, and/or the polar oxygen-free solvent into immediate or close proximity. In some embodiments, the contacting comprises bringing the metal halide precursor, the oxygen-containing compound, and/or the polar oxygen-free solvent into direct physical contact. In some embodiments, the contacting comprises mixing at least one of the metal halide precursor, the oxygen-containing compound, the polar oxygen-free solvent, or any combination thereof. In some embodiments, the contacting comprises forming a solution comprising the metal halide precursor and the polar oxygen-free solvent. In some embodiments, the contacting comprises adding the oxygen-containing compound dropwise to a solution comprising the metal halide precursor and the polar oxygen-free solvent.

The oxygen-containing compound may comprise a compound containing at least one oxygen. In some embodiments, the oxygen-containing compound is present in a liquid phase. In some embodiments, the oxygen-containing compound comprises a cycloalkyl comprising an oxygen heteroatom in the ring structure. In some embodiments, the oxygen-containing compound comprises an aryl comprising an oxygen heteroatom in the ring structure. In some embodiments, the oxygen-containing compound comprises tetrahydrofuran (THF).

The polar oxygen-free solvent may comprise a polar compound that does not comprise an oxygen-atom. In some embodiments, the polar oxygen-free solvent comprises dichloromethane (DCM). In some embodiments, the polar oxygen-free solvent comprises ethylene dichloride (EDC). In some embodiments, the polar oxygen-free solvent comprises chlorobenzene. In some embodiments, the polar oxygen-free solvent comprises at least one of dichloromethane (DCM), ethylene dichloride (EDC), chlorobenzene, or any combination thereof. In some embodiments, the method does not comprise a non-polar solvent. In some embodiments, at least two equivalents of the polar oxygen-free solvent relative to the metal halide compound is used.

The reaction product may be a reaction product of the metal halide precursor and the oxygen-containing compound. In some embodiments, the reaction product comprises a reaction product of the metal halide compound and the oxygen-containing compound. In some embodiments, the reaction product comprises an adduct of the metal halide compound and the oxygen-containing compound. In some embodiments, the reaction product comprises an adduct of the metal halide compound coordinated to the oxygen-containing compound. In some embodiments, the reaction product comprises any one or more of the metal halide compounds disclosed herein coordinated to tetrahydrofuran. For example, in some embodiments, the reaction product comprises at least one of YCl₃·2THF, YBr₃·2THF, YI₃·2THF, or any combination thereof. In some embodiments, the reaction product is dissolved in the polar oxygen-free solvent. In some embodiments, the at least one impurity is insoluble in the polar oxygen-free solvent. In some embodiments, the reaction product is a monomeric species. In some embodiments, the reaction product is a bis-THF complex. In some embodiments, the reaction products is not a salt compound (e.g., comprising anion and/or cation).

In some embodiments, the method does not comprise forming at least one of an anionic intermediate compound, a cationic intermediate compound, or any combination thereof. In some embodiments, the method does not comprise forming an anionic metal halide compound, a cationic metal halide compound, or any combination thereof. In some embodiments, the method does not comprise forming at least one of YCl₂(THF)₅, YCL₄(THF)₂, or any combination thereof. For example, in some embodiments, the method does not comprise forming at least one of trans-YCl₂(THF)₅, trans-YCL₄(THF)₂, or any combination thereof.

In some embodiments, the contacting step further comprises a nonpolar solvent, wherein a ratio of the nonpolar solvent to the polar solvent is 50:1 or less. For example, in some embodiments, the ratio of the nonpolar solvent to the polar solvent (e.g., polar oxygen-free solvent) is 0:1 to 50:1, 5:1 to 50:1, 10:1 to 50:1, 15:1 to 50:1, 20:1 to 50:1, 25:1 to 50:1, 30:1 to 50:1, 35:1 to 50:1, 40:1 to 50:1, 45:1 to 50:1, or any range or subrange between 0:1 and 50:1.

At step 106, in some embodiments, the reaction product is separated from at least one of at least a portion of the at least one impurity, at least a portion of the solution, or any combination thereof.

In some embodiments, the separating comprises separating by filtration. For example, in some embodiments, the separating comprises removing the at least one impurity by filtration. In some embodiments, the separating comprises removing the at least one insoluble impurity by filtration. In some embodiments, the separating comprises storing the solution comprising the reaction product and the at least one impurity sufficient to allow the at least one impurity to settle out. In some embodiments, the storing is performed at about room temperature for a duration of 1 minute to seven days, or any range or subrange between 1 minute to seven days. In some embodiments, the separating does not comprise sublimination. In some embodiments, the separating comprises reducing the solution to obtain the reaction product as a solid (e.g., a powder). In some embodiments, the separating is performed by recrystallization. In some embodiments, for example, the separating comprises one or more of concentrating the solution comprising the reaction product so as to exceed the solubility constant, cooling the solution, filtering solids from the solution, and obtaining a purified metal halide compound. In some embodiments, the separating comprises separating the at least one impurity from the reaction product by filtration, wherein the at least one impurity is insoluble in solution. In some embodiments, the separating comprises evaporating the solution sufficient to obtain a solid reaction product. In some embodiments, the separating comprises separating the reaction product from the at least one impurity by recrystallization.

In some embodiments, after separating the reaction product from at least a portion of the at least one impurity, the reaction product has a purity of 50% to 99.9999%. In some embodiments, the reaction product has a purity of 55% to 99.9999%, 60% to 99.9999%, 65% to 99.9999%, 70% to 99.9999%, 75% to 99.9999%, 80% to 99.9999%, 85% to 99.9999%, 90% to 99.9999%, 95% to 99.9999%, 96% to 99.9999%, 97% to 99.9999%, 98% to 99.9999%, 99% to 99.9999%, 99.9% to 99.9999%, 99.99% to 99.9999%, 99.999% to 99.9999%. In some embodiments, the reaction product has a purity of 50% to 99.999%, 50% to 99.99%, 50% to 99.9%, 50% to 99%, 50% to 98%, 50% to 97%, 50% to 96%, 50% to 95%, 50% to 90%, 50% to 85%, 50% to 80%, 50% to 75%, 50% to 70%, 50% to 65%, 50% to 60%, 50% to 55%, 50% to 54%, 50% to 53%, 50% to 52%, 50% to 51%.

In some embodiments, the metal halide precursor comprises at least one of YCl₃, YBr₃, YI₃, or any combination thereof. In some embodiments, the oxygen-containing compound comprises tetrahydrofuran (THF). In some embodiments, the polar oxygen-free solvent comprises dichloromethane (DCM). In some embodiments, the reaction product comprises at least one of YCl₃·2THF, YBr₃·2THF, YI₃·2THF, or any combination thereof.

Some embodiments relate to a composition. In some embodiments, the composition comprises a reaction product, such as, for example and without limitation, any one or more of the reaction products disclosed herein. In some embodiments, the reaction product comprises an adduct. In some embodiments, the adduct comprises a metal halide compound and an oxygen-containing compound. The metal halide compound may comprise any one or more of the metal halide compounds disclosed herein. The oxygen-containing compound may comprise any one or more of the oxygen-containing compounds disclosed herein. In some embodiments, the metal halide compound is coordinated to the oxygen-containing compound.

In some embodiments, the adduct is present in the composition at a purity of 50% to 99.9999%, or any range or subrange between 50% and 99.9999%. In some embodiments, a purity of the adduct present in the composition is at least 50%, at least 55%, at least 60%, at least 65%, at least 70%, at least 75%, at least 80%, at least 85%, at least 90%, at least 95%, at least 96%, at least 97%, at least 98%, at least 99%, at least 99.9%, at least 99.99%, at least 99.999%, at least 99.9999% or greater. In some embodiments, a purity of the adduct present in the composition is 90% to 99.9999%, 95% to 99.9999%, 96% to 99.9999%, 97% to 99.9999%, 98% to 99.9999%, 99% to 99.9999%, 99.9% to 99.9999%, 99.99% to 99.9999%, or 99.999% to 99.9999%.

The composition may have a low amount of the at least one impurity. The at least one impurity may comprise any one or more of the at least one impurities disclosed herein. In some embodiments, the composition comprises 0.0001% to 10% by weight of the at least one impurity, or any range or subrange between 0.0001% and 10%. In some embodiments, the composition comprises less than 10% by weight of at least one impurity. In some embodiments, the composition comprises less than 9%, less than 8%, less than 7%, less than 6%, less than 5%, less than 4%, less than 3%, less than 2%, less than 1%, less than 0.9%, less than 0.8%, less than 0.7%, less than 0.6%, less than 0.5%, less than 0.4%, less than 0.3%, less than 0.2%, less than 0.1%, less than 0.01%, less than 0.001%, less than 0.0001% by weight of the at least one impurity.

### Example

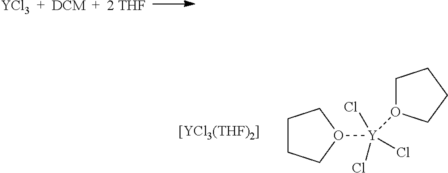

One pot synthetic process to produce YCl₃·2THF from YCl₃, dichloromethane (DCM), and tetrahydrofuran (THF). 120 g of a metal halide precursor comprising YCl₃ and various impurities was combined with 1L of dichloromethane (DCM). Thereafter, 176 mL of tetrahydrofuran (THF) was added dropwise to the solution comprising the YCl₃, various impurities, and DCM to form a solution. The resulting solution was stirred for 3 hours at room temperature and then allowed to settle for six hours to allow undissolved particles and other impurities to settle. The resulting solution was then transferred to another flask. It was determined that the resulting solution contained YCl₃·2THF in DCM. Solvent was evaporated to obtain a white powder of YCl₃·2THF. The YCl₃·2THF adduct was confirmed by ¹H NMR, TGA, and EA. Yield of YCl₃·2THF>98%.

### Aspects

Various Aspects are described below. It is to be understood that any one or more of the features recited in the following Aspect(s) can be combined with any one or more other Aspect(s).

Aspect 1. A method comprising:
obtaining a metal halide precursor, the metal halide precursor comprising a metal halide compound and at least one impurity;
contacting the metal halide precursor with an oxygen-containing compound in a presence of a polar solvent to form a reaction product in solution; and
separating the reaction product from at least one of at least a portion of the at least one impurity, at least a portion of the solution, or any combination thereof.

Aspect 2. The method according to Aspect 1, wherein the metal halide compound comprises at least one of yttrium chloride, yttrium bromide, yttrium iodide, yttrium fluoride, or any combination thereof.

Aspect 3. The method according to any one of Aspects 1-2, wherein the at least one impurity comprises at least one of a metal oxide, a metal hydroxide, a metal hydrate compound, or any combination thereof.

Aspect 4. The method according to any one of Aspects 1-3, wherein the at least one impurity comprises at least one impurity that is insoluble in the solution.

Aspect 5. The method according to any one of Aspects 1-4, wherein the contacting comprises:
forming a solution comprising the metal halide precursor and the polar solvent; and
adding the oxygen-containing compound dropwise to the solution.

Aspect 6. The method according to any one of Aspects 1-5, wherein the oxygen-containing compound comprises tetrahydrofuran (THF).

Aspect 7. The method according to any one of Aspects 1-6, wherein the polar solvent comprises a polar oxygen-free solvent comprising at least one of dichloromethane (DCM), ethylene dichloride (EDC), chlorobenzene, or any combination thereof.

Aspect 8. The method according to any one of Aspects 1-7, wherein the method does not comprise a non-polar solvent.

Aspect 9. The method according to any one of Aspects 1-8, wherein the reaction product comprises an adduct of the metal halide precursor coordinated to the oxygen-containing compound.

Aspect 10. The method according to any one of Aspects 1-9, wherein the separating comprises separating the at least one impurity from the reaction product by filtration, wherein the at least one impurity is insoluble in solution.

Aspect 11. The method according to any one of Aspects 1-10, wherein the separating comprises evaporating the solution sufficient to obtain a solid reaction product.

Aspect 12. The method according to any one of Aspects 1-11, wherein the separating comprises separating the reaction product from the at least one impurity by recrystallization.

Aspect 13. The method according to any one of Aspects 1-12, wherein, after separating the reaction product from at least a portion of the at least one impurity, the reaction product has a purity of 50% to 99.9999%.

Aspect 14. The method according to any one of Aspects 1-13, wherein:
the metal halide precursor comprises at least one of YCl₃, YBr₃, YI₃, or any combination thereof;
the oxygen-containing compound comprises tetrahydrofuran (THF);
the polar oxygen-free solvent comprises dichloromethane (DCM);
the reaction product comprises at least one of YCl₃·2THF, YBr₃·2THF, YI₃·2THF, or any combination thereof.

Aspect 15. A composition comprising:
an adduct of a metal halide compound and an oxygen-containing compound,
   wherein the oxygen-containing compound is coordinated to the metal halide compound;
   wherein the adduct is present in the composition at a purity of at least 50%.

Aspect 16. The composition according to Aspect 15, wherein the metal halide compound comprises at least one of yttrium chloride, yttrium bromide, yttrium fluoride, or any combination thereof.

Aspect 17. The composition according to any one of Aspects 15-16, wherein the oxygen-containing compound comprises tetrahydrofuran (THF).

Aspect 18. The composition according to any one of Aspects 15-17, wherein the composition comprises less than 10% by weight of at least one impurity.

Aspect 19. The composition according to Aspect 18, wherein the at least one impurity comprises at least one of a metal oxide, a metal hydroxide, a metal hydrate compound, or any combination thereof.

Aspect 20. The composition according to any one of Aspects 15-19, wherein the adduct is present in the composition at a purity of 90% to 99.9999%.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method comprising:
obtaining a metal halide precursor, the metal halide precursor comprising a metal halide compound and at least one impurity;
contacting the metal halide precursor with an oxygen-containing compound in a presence of a polar solvent to form a reaction product in solution; and
separating the reaction product from at least one of at least a portion of the at least one impurity, at least a portion of the solution, or any combination thereof.

2. The method of claim 1, wherein the metal halide compound comprises at least one of yttrium chloride, yttrium bromide, yttrium iodide, yttrium fluoride, or any combination thereof.

3. The method of claim 1, wherein the at least one impurity comprises at least one of a metal oxide, a metal hydroxide, a metal hydrate compound, or any combination thereof.

4. The method of claim 1, wherein the at least one impurity comprises at least one impurity that is insoluble in the solution.

5. The method of claim 1, wherein the contacting comprises:
forming a solution comprising the metal halide precursor and the polar solvent; and
adding the oxygen-containing compound dropwise to the solution.

6. The method of claim 1, wherein the oxygen-containing compound comprises tetrahydrofuran (THF).

7. The method of claim 1, wherein the polar solvent comprises a polar oxygen-free solvent comprising at least one of dichloromethane (DCM), ethylene dichloride (EDC), chlorobenzene, or any combination thereof.

8. The method of claim 1, wherein the method does not comprise a non-polar solvent.

9. The method of claim 1, wherein the reaction product comprises an adduct of the metal halide precursor coordinated to the oxygen-containing compound.

10. The method of claim 1, wherein the separating comprises separating the at least one impurity from the reaction product by filtration, wherein the at least one impurity is insoluble in solution.

11. The method of claim 1, wherein the separating comprises evaporating the solution sufficient to obtain a solid reaction product.

12. The method of claim 1, wherein the separating comprises separating the reaction product from the at least one impurity by recrystallization.

13. The method of claim 1, wherein, after separating the reaction product from at least a portion of the at least one impurity, the reaction product has a purity of 50% to 99.9999%.

14. The method of claim 1, wherein:
the metal halide precursor comprises at least one of YCl₃, YBr₃, YI₃, or any combination thereof;
the oxygen-containing compound comprises tetrahydrofuran (THF);
the polar solvent comprises dichloromethane (DCM); and
the reaction product comprises at least one of YCl₃·2THF, YBr₃·2THF, YI₃·2THF, or any combination thereof.

15. A composition comprising:
an adduct of a metal halide compound and an oxygen-containing compound,
wherein the oxygen-containing compound is coordinated to the metal halide compound;
wherein the adduct is present in the composition at a purity of at least 50%.

16. The composition of claim 15, wherein the metal halide compound comprises at least one of yttrium chloride, yttrium bromide, yttrium fluoride, or any combination thereof.

17. The composition of claim 15, wherein the oxygen-containing compound comprises tetrahydrofuran (THF).

18. The composition of claim 15, wherein the composition comprises less than 10% by weight of at least one impurity.

19. The composition of claim 18, wherein the at least one impurity comprises at least one of a metal oxide, a metal hydroxide, a metal hydrate compound, or any combination thereof.

20. The composition of claim 15, wherein the adduct is present in the composition at a purity of 90% to 99.9999%.
